(19) United States
(12) Patent Application Publication
(10) Pub. No.: US 2025/0349209 A1
(43) Pub. Date: Nov. 13, 2025

(54) DETECTION OF ANOMALOUS CONDITIONS USING ELECTRONIC USER DEVICE PROBE DATA

(71) Applicant: Apple Inc., Cupertino, CA (US)

(72) Inventors: Daniel S. Wolleb, Zurich (CH); Sandro Feuz, Zurich (CH); Asier Mujika Aramendia, Zurich (CH); Daniel Metzger, Cupertino, CA (US); Daniel Chen, Sunnyvale, CA (US); Johannes Kapfhammer, Zurich (CH); Christian Sommer, Lug (CH)

(73) Assignee: Apple Inc., Cupertino, CA (US)

(21) Appl. No.: 19/203,614

(22) Filed: May 9, 2025

Related U.S. Application Data
(60) Provisional application No. 63/645,792, filed on May 10, 2024.

(51) Int. Cl. G08G 1/01

(52) U.S. Cl. CPC G08G 1/0129; G08G 1/0133

(57) ABSTRACT

Techniques are disclosed for determining anomalous conditions of paths or segments of paths on which vehicles are traveling. A computer system can access a first collection of first path offsets along a segment. The first path offsets can correspond to prior user device probe data generated during a prior interval. The computer system can determine second path offsets along the segment based on current user device probe data generated during a current interval. The computer system can generate a second collection of the second path offsets along the segment using the second path offsets and compare the first collection and the second collection in accordance with a change criterion to identify a difference that represents an anomalous condition along the segment. The computer system can then generate incident information based on the difference.

### CROSS-REFERENCES TO RELATED APPLICATIONS

This application claims priority under 35 U.S.C. § 119(e) to U.S. Provisional Application Ser. No. 63/645,792, filed May 10, 2024, entitled “INCIDENT DETECTION USING PROBE DATA DISTRIBUTIONS,” which is incorporated herein by reference in its entirety.

### BACKGROUND

Probe data collected by global positioning system (GPS) chips in electronic user devices may be sent to a server system and used by the server system to estimate movement of the electronic user devices. For example, such data may be used to estimate volume, speed, and direction of vehicles (in which the user devices are traveling) along a segment of a path (e.g., a roadway).

### BRIEF DESCRIPTION OF THE DRAWINGS

FIG. 1 illustrates a block diagram and a flowchart showing a process for generating incident information using collections of path offsets, according to at least one example

FIG. 2 illustrates a diagram including a single set of probe data along a path, according to some embodiments.

FIG. 3 illustrates a diagram depicting a prior distribution of probe data, according to some embodiments.

FIG. 4 illustrates a diagram depicting the prior distribution for multiple intervals, according to some embodiments.

FIG. 5 illustrates a diagram depicting prior probe data corresponding to a typical day, according to some embodiments.

FIG. 6 illustrates a diagram that includes a shifting disruption and a closure disruption, according to some embodiments.

FIG. 7 illustrates a plot of probe data events at one point along a segment for a time interval, according to some embodiments.

FIG. 8 illustrates a flowchart showing an example process for implementing techniques relating to generating incident information, according to at least one embodiment.

FIG. 9 illustrates a diagram that includes a systematic, direction-dependent offset in probe trajectories, according to some embodiments.

FIG. 10 illustrates a flowchart showing another example process for implementing techniques for detecting a systematic offset, according to at least one embodiment.

FIG. 11 illustrates an example architecture or environment configured to implement techniques described herein, according to at least one embodiment.

### DETAILED DESCRIPTION

The examples described herein relate to techniques, devices, systems, computer-readable media, and the like for determining a current roadway disruption based on historical (e.g., prior) and current collections (e.g., distributions) of trajectories. The probe paths (e.g., trajectories) may be generated from probe data that is received from electronic user devices. In some examples, users of the electronic user devices may opt-in to share anonymized location data (e.g., probe data) with a service provider. The service provider may aggregate the probe data from many different electronic user devices and identify trends in the data. The techniques described herein relate to a particular approach for using current probe data (e.g., for a current time period) from electronic user devices that are moving along roadways (e.g., within vehicles) to identify disruptions along the roadways. For example, the techniques may be used to infer that one lane of a typical three-lane freeway is closed or that one or more lanes of the three-lane freeway is being shifted (e.g., directed onto a different part of the roadway than where cars historically drive).

The techniques described herein may provide multiple technical improvements, benefits, and advantages with respect to prior solutions. For example, conventional roadway condition information (e.g., information about roadway disruptions) may be obtained from a roadway authority (e.g., via a service that outputs information about roads). Such information may be incorrect or stale, in some examples. The techniques described herein may validate the roadway condition information using real-time probe data compared with historical probe data to ensure that the roadway condition information can be relied upon. For example, the roadway condition information may indicate that a lane on a freeway is closed. The techniques described herein can confirm whether the vehicle movements patterns correspond to the closure. If so, communications can be sent to electronic user devices to inform them about the closure. If not, communications may not be sent. The techniques described herein may also be used to augment the roadway condition information (e.g., to provide additional guidance beyond what is included in the roadway condition information).

In addition, the techniques described herein can detect a change in roadway condition more quickly and more accurately than conventional methods like official announcements. For example, probe data including geolocation information can be used to quickly determine that a road lane has become obstructed due to events like vehicle breakdowns, without waiting for an official identification or announcement of the closure. As another example, a change in roadway condition can be detected much more quickly after the change occurs. Probe data from one or more electronic user devices can be accumulated and evaluated in near-real time to determine if vehicle trajectories have shifted more than a threshold amount, indicating obstructions, blockages, closures, or other disturbances to the operation of the vehicles on the path. The disturbance may be detected within several minutes of the disturbance originating, which can be minutes or hours more quickly than conventional third-party reporting based on official data or from reports from users.

As a further advantage, the detected disturbances to the trajectories of the electronic user devices can be used to update routing, mapping, or other navigation systems accessible to the electronic user devices. For example, a map route for navigating a vehicle may be displayed on the electronic user device. If a disturbance is detected (e.g., based on data obtained from other electronic user devices traveling on the same path), the map route can be updated automatically, which can include selection of alternate routes to avoid the disturbance on the path. In some instances, the updated navigation information can be used by a control system to operate a vehicle in accordance with the route and the information about the disturbance. For example, an automatic piloting system for the vehicle may operate the vehicle to change lanes on the roadway in anticipation of a detected lane closure ahead on the path. As another example, the automatic piloting system for the vehicle can slow the vehicle down prior to arriving at a detected lane shift due to construction, thereby avoiding rapid deceleration events if the vehicle suddenly comes upon a slowdown in the road.

Implementation of the techniques described herein may conserve bandwidth resources. For example, rather than just “forwarding” roadway condition information to all electronic user devices within an area, the techniques described herein may validate the roadway condition information and then selectively send communications (e.g., to a set of electronic user devices approaching a disruption based on current probe data). This can include not sending communications and/or sending communications to only a certain subset of devices that might be impacted by the roadway disruption. This process of selectively sending communications represents a technical improvement over conventional systems.

Users of electronic user devices may have improved user experiences with roadway condition information as compared to conventional approaches. This is because using the techniques described herein validates the roadway condition information and ensures that stale and/or incorrect information is not shared with electronic user devices. Such incorrect or stale information may not only provide a poor user experience but may also contribute to unsafe vehicle operating conditions if the information causes a driver to operate the vehicle in an unsafe manner considering the roadway conditions.

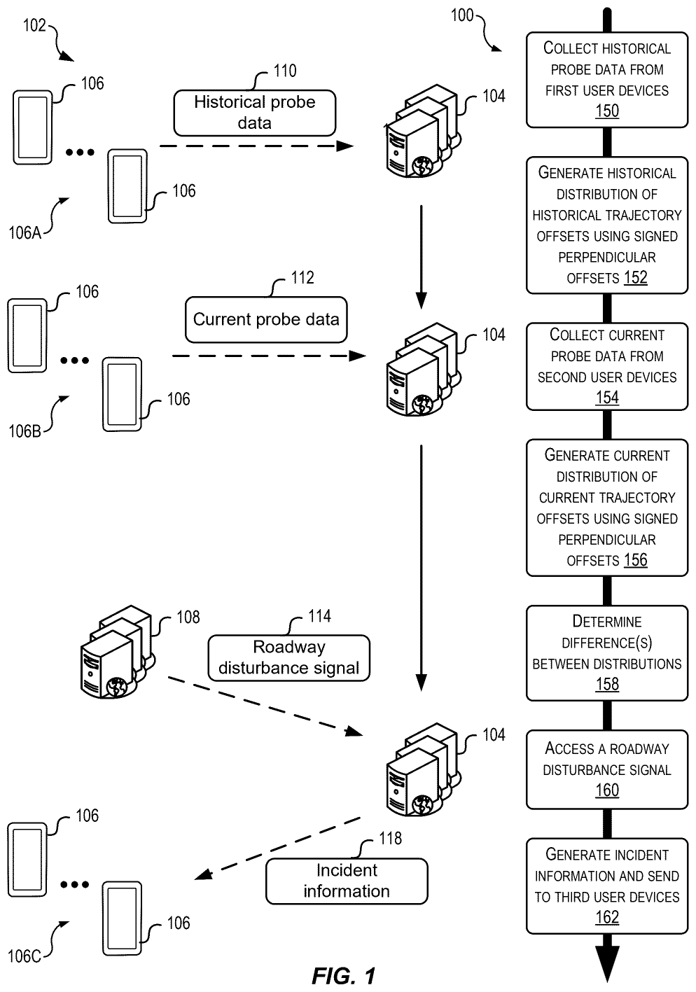

A particular example of the techniques described herein is shown in FIG. 1. This figure includes a block diagram 102 and a flowchart showing a process 100 for generating incident information using collections (e.g., distributions) of path (e.g., trajectory) offsets, according to at least one example. The diagram 102 includes a service provider 104, which is any suitable combination of computing devices such as one or more server computers, which may include virtual resources, capable of performing the functions described with respect to the service provider 104. For example, the service provider 104 may include one or more different servers and/or services dedicated to receiving and processing probe data and communicating with electronic user devices.

The diagram 102 also includes user devices 106 (e.g., examples of the electronic user devices described herein). The user devices 106, which may be any suitable device such as a smartphone, tablet, smartwatch, wearable device, laptop computer, in vehicle infotainment center, and the like, may be configured to interact with the service provider 104. The diagram also includes a roadway authority server 108.

FIGS. 1, 8, and 10 illustrate example flow diagrams showing processes 100, 800, and 1000, according to at least a few examples. These processes, and any other processes described herein, are illustrated as logical flow diagrams, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

All probe data described herein may correspond to geolocation coordinates and timestamps, as output from geolocation devices (e.g., global navigation satellite system (GNSS) devices like global positioning system (GPS) chips) of the user devices 106. In some examples, the probe data described herein may also include accuracy information and a trip identifier that identifies a trip with which the probe data is associated. The accuracy information may be used by the service provider 104 to identify outliers. The trip identifier may change over time to prevent identification of the particular user device 106. The service provider 104 may use the trip identifier to associate multiple probe data points together to define a trip. The probe data may be collected by the user devices 106 at any suitable frequency (e.g., 0.1 HZ to 1 HZ or greater), and may be shared with the service provider 104 at any suitable frequency (e.g., every minute, every two minutes, every five minutes, etc.). In some embodiments, the probe data can also include speed data corresponding to the geolocation devices. The speed data may be computed from the geolocation data and timestamp information or may be determined from a GNSS system.

The process 100 may begin at block 150 by the service provider 104 collecting historical probe data 110 (e.g., prior probe data) from first user devices 106A. This may be collected over multiple periods of time (e.g., multiple intervals), for example daily, over a month, or some other period of time. The length of the period of time may vary depending on the amount of traffic on the roadway segment, seasonality, timing of traffic, weather conditions, and the like.

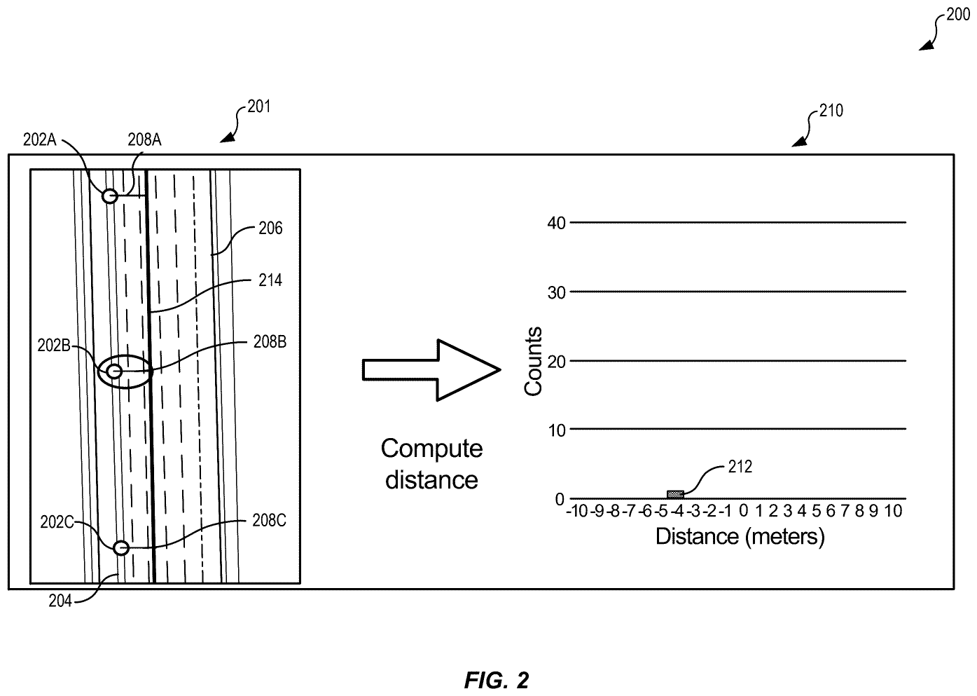

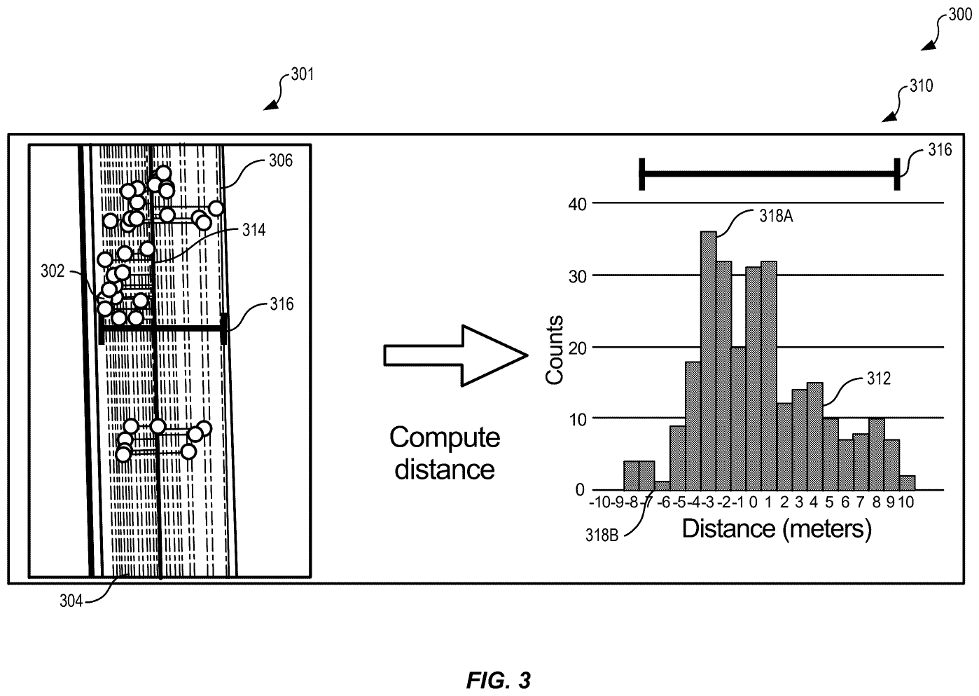

At block 152, the service provider 104 may generate a historical distribution (prior collection) of historical trajectory offsets (prior path offsets) using signed perpendicular offsets. FIG. 2 illustrates diagram 200 including a single set of probe data 201 including three geolocation positions 202A-202C, a trajectory 204, a centerline 214 of a roadway 206, and a distribution 210 showing just a single data point 212 corresponding the geolocation position 202B along the trajectory 204. In some examples, part of generating the trajectory 204 may include implementing a map matching technique. M ap matching techniques may include associating the probe data 201, including the geolocation positions 202, with the roadway 206. Techniques for map matching are generally known. The distribution 210 is the beginning of a prior distribution, which is shown in more detail in FIG. 3. The trajectory 204 (e.g., each of the geolocation positions 202) is perpendicularly offset from the centerline 214 a signed perpendicular distance 208 (e.g., 208A-208C). In the distribution 210, signed perpendicular distances that are to the right of the centerline 214 are on the positive side of the distribution 210, while signed perpendicular distances that are to the left of the centerline 214, e.g., the signed perpendicular distance 208B, are on the negative side of the distribution 210.

FIG. 3 illustrates diagram 300, which depicts a historical distribution 310 (e.g., a prior distribution) showing many data points 312 corresponding to many geolocation positions 302 along many trajectories 304 (paths) of many sets of probe data 301. Generating the trajectories may also include map matching. Block 152 may also include generating the distribution 310. The distribution 310 extends from about −8 to about +10 meters. For the roadway 306, this may represent the typical flow of vehicular traffic, e.g., spread out across the entire roadway. However, to account for possible outliers, the data that is below the 5^{th} percentile and above the 95^{th} percentile may be ignored or otherwise removed from the distribution 310. For example, as shown in the diagram 300, a bracket 316 represents a width of the roadway 306 with respect to the roadway and the percentile reduction with respect to the distribution 310. The distribution 310 (and the other distributions described herein) may be represented as histograms or other frequency plotting techniques. In some examples, the distribution 310 is stored data, and is not presented as a diagram, as shown. In the distribution 310 the highest count of data points is in column 318A at −3 meters from the centerline 314 and a count total of around 38. Meaning for the period of time for which the distribution 310 covers (e.g., one hour, one day, one week, one month, etc.) around 38 user devices 106A were recorded as having traveled along the roadway 306 at a location that is 3 meters to the left of the centerline 314. The lowest count of data points 312 is in column 318B at −6 meters from the centerline 314 and a count total of around 1.

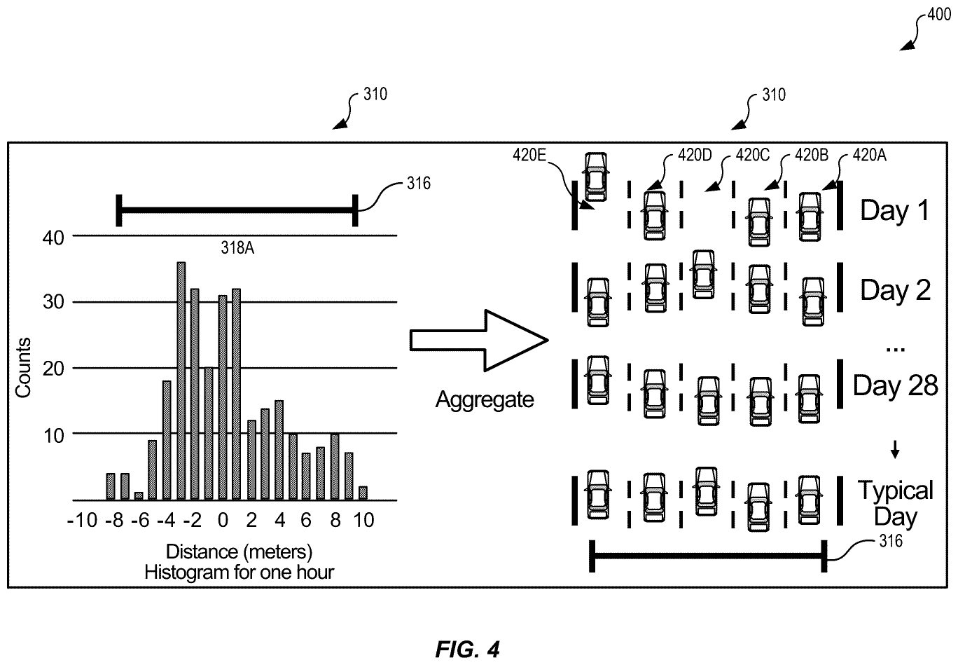

FIG. 4 illustrates diagram 400, which depicts the historical distribution showing and how the historical distribution 310 can be computed for multiple intervals. For example, block 152 may also include combining generated distributions from multiple hours over multiple days to obtain a distribution that covers more than one day, e.g., a week, a month, etc. In some examples, multiple distributions 310 may represent a single day, e.g., daytime distribution, an evening distribution, a morning rush hour distribution, an evening rush hour distribution, a weekday distribution, a weekend distribution, etc. Diagram 400 also depicts example lanes 420A-420E and vehicles traveling in the lanes 420A-420E and the bracket 316.

The process 100 continues at block 154 by the service provider 104 collecting current probe data 112 from second user devices 106B. Collecting the current probe data 112 may include collecting the current probe data 112 from the second user devices 106B when those user devices are traveling in vehicles along the roadway.

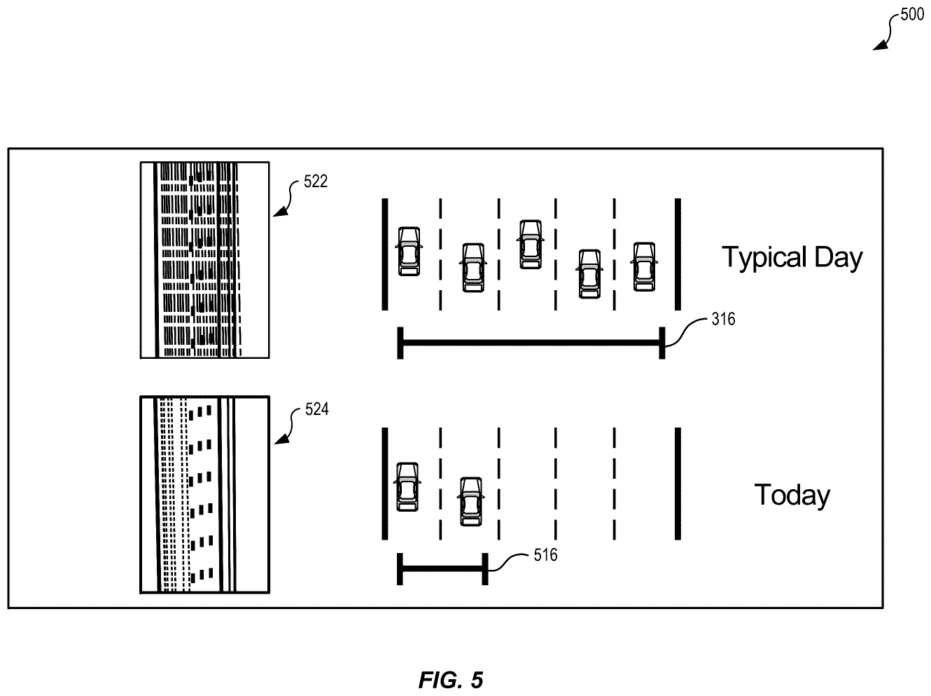

FIG. 5 illustrates diagram 500, which depicts historical probe data 522 corresponding to a typical day (e.g., a historical period). The historical probe data 522 corresponds to the many geolocation positions 302 of the sets of probe data. The bracket 316 shows the width of traffic on a typical day. The diagram 500 also depicts current probe data 524 (e.g., the current probe data 112) corresponding to a current day (e.g., “today”). As is shown in FIG. 5, the current probe data 524 is constrained in the lanes on the far left of the roadway 506, which is represented by bracket 516 showing that the vehicles are all traveling along the left two lanes.

The process 100 continues at block 156 by the service provider 104 generating a current collection of current path offsets using signed perpendicular offsets. Block may be performed using the current probe data 112 in the same manner described with respect to block 152 for the historical probe data. The current collection will be generated for a current time interval, e.g., current day, current hour, etc. Returning to FIG. 5, the current collection has more values in the leftmost side of the graph to represent the probe data 524, indicating that almost all vehicles are traveling in the leftmost lanes.

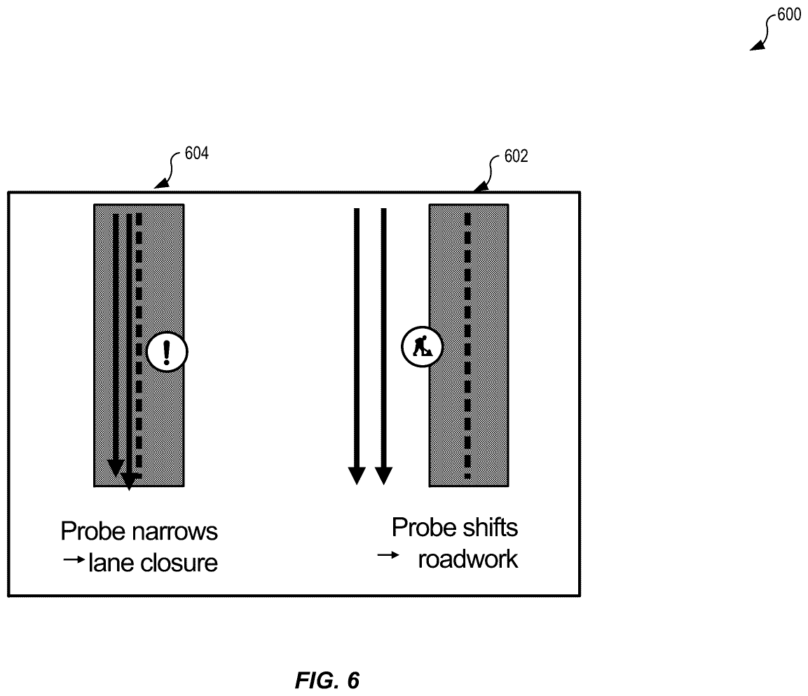

At block 158, the process 100 includes the service provider 104 determining differences between collections, e.g., between the historical distribution and the current distribution. This may include performing operations on one or both of the distributions for comparison purposes. FIG. 6 illustrates diagram 600 that includes a lane shifting disruption and a lane closure disruption 604.

Turning first to the lane shifting disruption 602, the service provider 104 may identify the 50^{th} percentile of each distribution for each distribution and compare the same. If the 50^{th} percentile in the current distribution has moved beyond some threshold (e.g., 5 meters, meters, etc.) to the left or right of the centerline, the service provider 104 may determine that the lanes have shifted. Turning now to the narrowing disruption 604, if the comparison reveals that the current distribution includes no data at certain locations (e.g., at one end of the distribution) and/or more data points at other locations (e.g., at the other end of the distribution), the service provider 104 may determine that one or more lanes on the side of the road have been closed. Similarly, if the distribution shows that vehicular traffic is moving entirely to one side of the road, the service provider 104 may determine that more lanes have been closed or the traffic may be being rerouted due to an accident or other disruption. In some examples, the service provider 104 may be unable to map match the probe data to the roadway. In this example, the service provider 104 may determine that the road segment in question is closed or is that traffic is otherwise being detoured around the road segment.

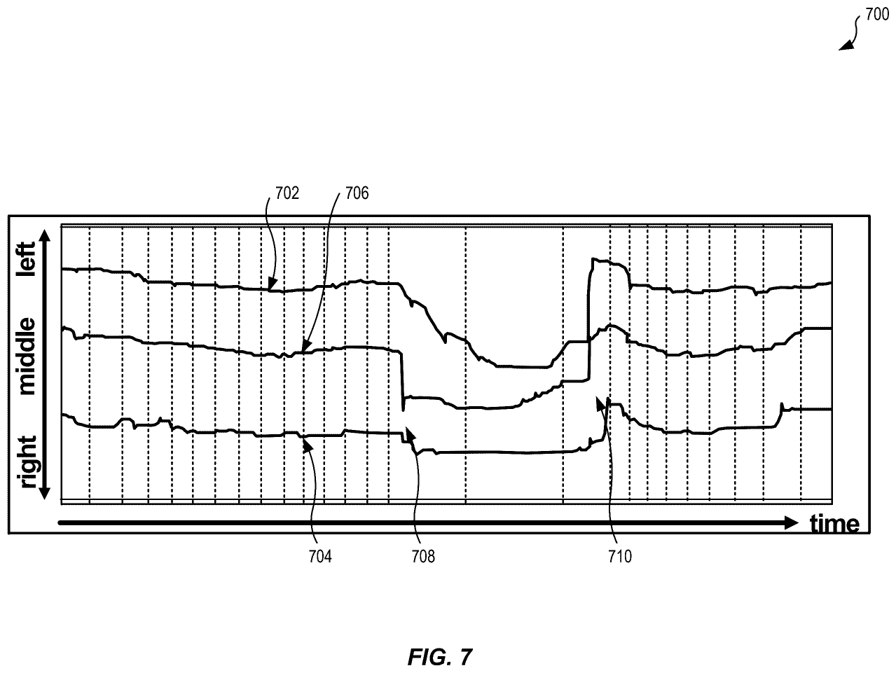

FIG. 7 illustrates a plot 700 of probe data events at one point along a segment (e.g., road segment) for a time interval, according to some embodiments. For each point on the time axis of the plot 700, probe data events can be collected representing the geolocation position of the probe (e.g., user devices in a vehicle) relative to the road position axis. These probe data event points are not shown in FIG. 7 for clarity, but each vertical dashed partition of the time axis can include probe data events for a fixed number of probes (e.g., 1,000 vehicles). The plot 700 includes lines 702-706 indicating the median position (50^{th} percentile), left position (95^{th} percentile), and right position (5^{th} percentile) relative to the position axis of the road segment. The left position line 702 and the right position line 704 can indicate the bounds (of the road width) that encompass 90% of all probe events for the corresponding point in time (e.g., 90% of vehicles passing the one point along the road segment are between left position line 702 and the right position line 704). The median position line 706 can indicate the median position along the road width of all probes passing the one point along the road segment.

As shown in FIG. 7, the plot 700 can indicate road disruptions with a shift of one or more of the lines representing the positions of the probe data events along the width of the road segment. At time 708, a rapid shift to the right for the median position line 706 occurs, with an associated more gradual shift to the right of the left position line 702. The right position line 704 only exhibits a small rightward shift at time 708. As described herein, the shift in the lines from the probe data events can exceed a threshold indicating a disturbance or other affect to the flow of traffic along the road segment. For instance, the left position line 702 may shift more than 2 m to the right at time 708. Such a shift can indicate a lane closure of a leftmost lane along the road segment. At time 710, the median position line and the left position line shift back to the left, indicating that the lane closure has ended.

In addition to shifts of the position lines exceeding a threshold, the service provider system can detect contraction or widening of the distribution of vehicles along the width of the road segment based on the left position line 702 and the right position line 704. For example, a contraction of the width between the left position line 702 and the right position line can indicate road work long both shoulders of the road segment (e.g., staging of equipment, obstruction of non-travel shoulder lane) which can correlate to a reduction in speed of traffic in the segment even if no travel lanes close and no lane shift occurs.

As compared to the discussion above with respect to FIGS. 4 and 5, the data to the left of time 708 (e.g., earlier in time) can be considered a first distribution of trajectory offsets, while the data to the right of time 708 but left of time 710 can be considered a second distribution of trajectory offsets. Rather than determining a typical distribution of trajectory offsets for the road for a relatively long period of time (“historical” distribution data), the service provider system can accumulate data in near real time to detect deviations from a prior typical state to a state indicating a disturbance. This allows the service provider system to determine the start/end points of the detected disturbance more accurately.

At block 160, the process 100 may include the service provider 104 accessing an anomalous condition signal 114 (e.g., a roadway disturbance signal). The anomalous condition signal 114 may be output by the roadway authority service 108. The roadway authority service 108 may be operated by an entity that is responsible for sharing information about roadway conditions. In some examples, the roadway authority service 108 may be operated by a department of transportation for the area in question. The roadway authority service 108 may publish periodically, when triggered, or at other times certain information about roadway conditions such as the roadway disturbance signal 114. The anomalous condition signal 114 may include information that identifies the roadway in question (e.g., a road segment identifier), a time range for the disturbance (e.g., a few hours, all day, unknown, etc.), a type of disturbance (e.g., planned road construction, emergency vehicles, accident, adverse weather, closure, etc.), and any other suitable information. In some examples, the roadway disturbance signals 114 are also received by the user devices 106.

At block 162, the service provider 104 may generate incident information and send to third user devices 106C. The incident information 118 may be based on the differences between collections computed at block 158 and/or the anomalous condition signal obtained and processed at block 160. In some example, generating the incident information may include verifying the anomalous condition signal 114. For example, the anomalous condition signal 114 may indicate that the right two lanes will be closed between mile markers and 42 along Interstate 5. The service provider 104 may compare a real-time (e.g., current) distribution for those 4 miles (or those 4 miles +or − a few more) with a prior distribution for the same area to validate the accuracy of the roadway disturbance signal 114, and use that validation as part of generating the incident information. The service provider may also use the comparison data to augment the roadway disturbance signal 114.

In some embodiments, the incident information 118 may indicate a different condition than the anomalous condition signal 114. For example, the anomalous condition signal 114 may indicate road work on a road segment that would correspond with a lane shift or a general reduction in the speed of vehicles through that road segment. However, the incident information 118 generated by the service provider 104 may actually reveal that the road work has resulted in one or more lane closures of the road segment. Because the lane closure may be a more serious disturbance to traffic than a lane shift, the service provider 104 can use the incident information to provide an alert to user device 106C reflecting the more serious disturbance, as opposed to providing, for example, an informational indication of general road work at the road segment.

The incident information 118 may be used by the user devices 106C to add information to a map view in map applications of the user devices 106C. For example, a user device 106C may use the incident information 118 to generate an icon in a browsing mode of a map view of the map application so a viewer would be able to view disturbances on the map. In other examples, the incident information 118 may be notifications to the user devices 106C while the user devices 106C are navigating using the map application. In some examples, alerts and/or notifications may alert users generally about upcoming lane closures, slow downs, reroutes, and the like. In some examples, more refined alerts may be provided to the user devices 106C may include more granular information (e.g., “left lane closed,” “accident up ahead,” etc.). In some examples, a slowdown in traffic, which may be derived from a different traffic service, may trigger the blocks 156-162.

In addition, the incident information 118 can be provided to third party systems and databases to update those systems with the more accurate incident detection. For example, a transportation authority may have a database of current roadway incidents compiled from user reports, manually reviewed traffic cameras, law enforcement reports, or the like, which may be slow to provide information about new incidents affecting vehicles moving on various roads. The transportation authority database can be configured to receive incident information to update the incidents in near-real time as they are detected.

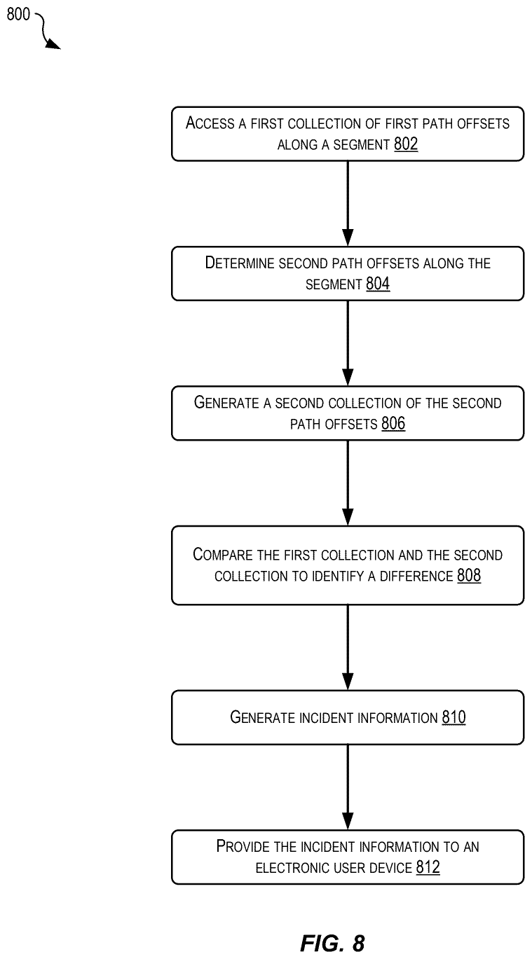

FIG. 8 illustrates a flowchart showing an example process 800 for implementing techniques relating to generating incident information, according to at least one example. The process 800 may be performed by the service provider 104. The process 800 may include at least some portions that may be pre-computed, some that may be computed in real-time and some that may be performed in about real-time or shortly after a triggering event. For example, a historical distribution may be precomputed, a current distribution may be computed in about real-time, and a comparison may be computed in real-time.

The process 800 may begin at block 802 by the service provider 104 accessing a first collection of first path offsets along a segment (e.g., a road segment. The first path offsets may correspond to prior (e.g., historical) user device probe data generated during a historical period. In some examples, the prior probe data comprises geolocation points obtained from geolocation devices of electronic user devices moving along the segment during the prior period. In some examples, the prior period may include a summation of a plurality of sub-prior periods.

At block 804, the process 800 includes the service provider 104 determining second path offsets along the segment. The second path offsets may be based on current user device probe data generated during a current period. In some examples, the current period occurs after the prior period. In some examples, the prior period has a first length that is longer than a second length of the current period.

At block 806, the process 800 includes the service provider 104 generating a second collection of the second path offsets. The second path offsets may extend along the segment using the second path offsets. In some examples, a particular path offset of the second path offsets represents a particular path of a single electronic user device along the segment and includes a plurality of geolocation points. In some examples, the particular path offset may include, for each geolocation point of the plurality of geolocation points, a signed perpendicular distance from a centerline of the segment. In some examples, generating the second collection of the second path offsets may include adding a count to the second collection at the signed perpendicular distance value. In some examples, the second collection may include a rolling window that is updated at a regular interval.

In some examples, the first collection includes a first histogram and the second collection includes a second histogram. In some examples, the second collection represents a current estimated width of the segment and current estimated borders of the segment. In some examples, the current estimated width of the segment is different than a prior estimated width of the segment represented by the first collection.

At block 808, the process 800 includes the service provider 104 comparing the first collection and the second collection to identify a difference. This may be performed in accordance with a change criterion. The change criterion may include operations performed on the collections in order to analyze and compare the collections. The difference may represent an anomalous condition along the segment.

In some examples, the change criterion may include a collection width criterion. The difference may represent that the second collection is narrower than the first collection. In some examples, the anomalous condition may include a narrowing of lanes along the segment. For example, if the current estimated width of the segment is less than the prior estimated width of the segment by more than 2 m, then the change criterion can be a reduction in current estimated width of 2 m.

In some examples, the change criterion may include a collection center criterion. The difference may represent that a median of the second collection is offset from a median of the first collection. In some examples, the anomalous condition may include a shifting of lanes along the road segment. For example, if the offset of the median of the second collection (the current estimated median deviation from the roadbed centerline) deviates from the median of the first collection (the historical estimated median deviation from the roadbed centerline) by more than 5 m in either direction, then the change criterion can be a median deviation exceeding m.

At block 810, the process 800 includes generating incident information based on the distribution difference. In some examples, the process 800 may further include receiving an anomalous condition signal. In this example, generating the incident information may include generating the incident information based on the anomalous condition signal. In some examples, the anomalous condition signal may indicate an anomalous condition to the road segment. In some examples, receiving the anomalous condition signal may include receiving the anomalous condition signal from a computing system of a transportation authority.

At block 812, the process 800 may further include sending or providing the incident information to an electronic user device that is adjacent to or approaching the segment. In this example, the incident information may cause the electronic user device to present information about the anomalous condition. In some examples, the incident information comprises a notification that is sent to the electronic device.

In some embodiments, the process 800 can be performed for multiple segments that are adjacent or contiguous. For example, a first road segment could include a portion of a road and a second road segment could include a second portion of the same road a short distance away from the first road segment. Because an incident affecting the first road segment is likely to also affect the second road segment, incident information for the first road segment can be combined with incident information generated for the second road segment using process 800 to provide incident information that covers both road segments. As an example, the combined incident information can be used to determine that a single incident is affecting both road segments, so that only one alert or other indication is transmitted to user devices navigating on those road segments.

In some examples, the incident information generated from the second road segment can indicate a further change in the roadbed conditions (e.g., a further lane shift, a further narrowing, lanes restored, etc.) resulting from the single incident. The combined incident information can then be used to provide indications or alerts to user devices that provide updates to the conditions, rather than repetitively signaling the same incident for separate road segments. In some embodiments, the incident information generated for different road segments can be combined based on a determination that traversing one of the road segments implies traversing the other road segment.

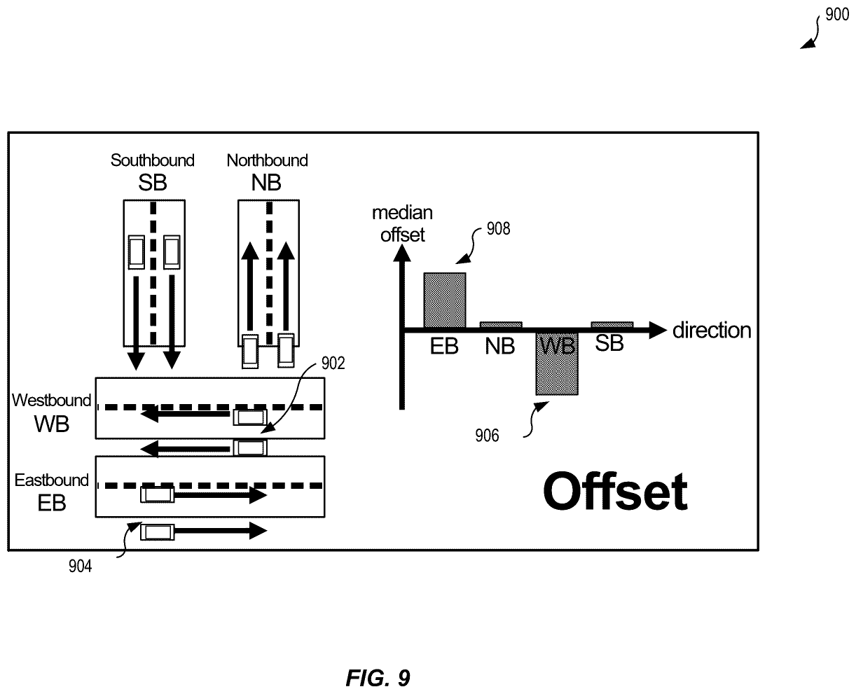

FIG. 9 illustrates a diagram 900 that includes a systematic, direction-dependent offset in probe trajectories, according to some embodiments. Westbound trajectories can be shifted left relative to the centerline of a road segment, while eastbound trajectories can be shifted right relative to the centerline of a road segment. The westbound median offset 906 and the eastbound median offset 908 are depicted in the plot of diagram 900. In both cases, the offset is systematically “south” relative to the centerline of the road segment. Such systematic, direction-dependent offsets can be due to operational artifacts of the geolocation system used to collect probe data.

As described above, GNSSs like GPS can be used to determine the location of a user device (e.g., a smart phone) while it travels in a vehicle. Because the location data determined by GNSS is sensitive to the timing of signals transmitted from the satellites to the receivers on the user devices, atmospheric effects can induce errors to the location data determined by the GNSS. For example, ionospheric effects can introduce signal delays to the signals transmitted from the satellite system to the user device. Such ionospheric effects can depend on the time of day (e.g., strengthening during midday/afternoon due to increased atmospheric insolation) and the latitude at which the GNSS receiver is located (e.g., more pronounced errors in the tropics/closer to the equator). The errors can be systematic in a particular direction (e.g., preferentially shifting location measurements to the south), and therefore may induce errors in direction-dependent calculations like median trajectory offsets described herein. M any modern GNSSs can correct for some of these errors, but the error correction may not be sufficiently accurate for the calculations needed to determine anomalous conditions (e.g., with detection thresholds of approximately 2 m of shift) or occur quickly enough to adapt to the daily cyclical ionospheric effect (e.g., may not correct the error prior to detecting spurious offsets).

To account for the systematic, direction-dependent offset, techniques described herein can detect when a systematic offset exists or has developed and perform further actions to accommodate the detected offset. For example, a service provider system (e.g., service provider 104 of FIG. 1) can determine that eastbound median offset 908 exceeds a threshold (e.g., 2 m from centerline) and that westbound median offset 906 exceeds a threshold (e.g., 2 m from centerline) in the opposite direction. If both thresholds are exceeded, then the service provider may stop detecting disturbances or determining road incident information for the associated road segment. In some examples, the service provider can stop detecting “lane shift” disturbances for the road segment but continue detecting “lane closure” disturbances, since probe data corresponding to lane closures is less likely to be affected by systematic, direction-dependent offsets. As described above, determining a lane closure disturbance can be based on the width of paths (e.g., the difference between the 5^{th} percentile and 95^{th} percentile of all measured probe paths) of vehicles in the road segment. Evaluating this difference is invariant to systematic offsets (e.g., “shifts”) in the paths, so detecting lane closures according to the techniques herein may be unaffected by the systematic offsets.

In some examples, upon detecting that both thresholds are exceeded, the service provider can adjust a detection threshold for a lane shift to be higher than the detected systematic offset. For example, if a threshold for determining a lane shift is at 2 m and the service provider determines that a systematic offset of 2 m is present, the service provider can increase the threshold for determining the lane shift to 5 m. In this case, a more extreme deviation of the median trajectory from the centerline of the road segment would have to occur before the service provider determined that a lane shift had occurred. Additionally or alternatively, the service provider could require confirmation of a detected lane shift using third party data during the times when a systematic, direction-dependent offset is detected.

As noted above, the systematic offset may be direction-dependent. As shown in FIG. 9, road segments that are primarily north-south orientation may not be affected by the offset present for westbound trajectories 902 and eastbound trajectories 904. If a service provider detects the systematic, direction-dependent offset and takes further action for certain road segments (e.g., primarily east-west oriented road segments), the service provider can continue to determine road disturbance events for the other road segments (e.g., primarily north-south oriented road segments) without further adjustment, including detecting lane shifts and lane closures.

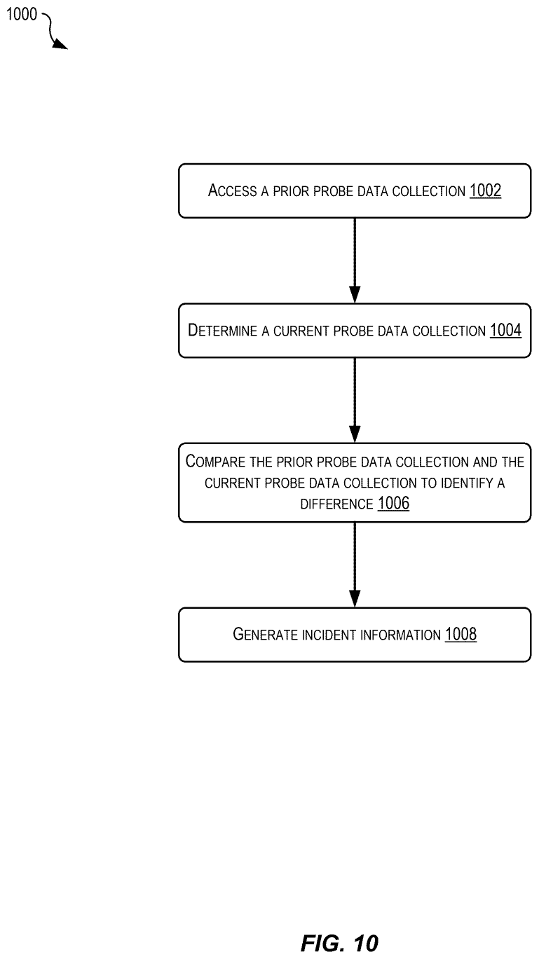

FIG. 10 illustrates a flowchart showing another example process for implementing techniques for detecting a systematic offset, according to at least one embodiment. The process 1000 may be performed by the service provider 104. The process 1000 may include at least some portions that may be pre-computed, some that may be computed in real-time and some that may be performed in about real-time or shortly after a triggering event. For example, a prior collection may be precomputed, a current collection may be computed in about real-time, and a comparison may be computed in real-time.

The process 1000 may begin at block 1002 by the service provider 104 accessing a prior probe data collection. The prior probe data collection can include first path offsets along a segment (e.g., road segment). The first path offsets may correspond to prior user device probe data generated during a prior interval. In some examples, the prior probe data comprises geolocation points obtained from geolocation devices of electronic user devices moving along the road segment during the prior period. In some examples, the prior interval may include a summation of a plurality of sub-intervals.

At block 1004, the process 1000 includes the service provider 104 determining a current probe data collection along the road segment. The current probe data collection can include second path offsets based on current user device probe data generated during a current period. In some examples, the current period occurs after the prior period. For example, the current probe data collection can include second path offsets obtained from a user device currently traveling in a vehicle along the road segment.

At block 1006, the process 1000 can include the service provider 104 comparing the prior probe data collection and the current probe data collection to identify a difference. This may be performed in accordance with a change criterion. The change criterion may be a threshold value corresponding to a shift in a median position of a vehicle represented by the current probe data collection. The difference may represent a roadway disruption along the road segment.

At block 1008, the process 1000 includes generating incident information based on the difference. In some examples, the process 1000 may further include receiving a roadway disturbance signal. In this example, generating the incident information may include generating the incident information based on the roadway disturbance signal. In some examples, the roadway disturbance signal may indicate a disturbance to the road segment. In some examples, receiving the roadway disturbance signal may include receiving the roadway disturbance signal from a transportation authority.

In some embodiments, the process 1000 can further include the service provider 104 determining a systematic offset in the difference between the prior probe data collection and the current probe data collection. The service provider 104 can perform a corrective action based on the systematic offset. The systematic offset can include an offset of a median of the current probe data collection from a median of the prior probe data collection. For example, a median of the paths of vehicles on a road segment may be shifted in one direction due to error in the geolocation data of the current probe data collection caused by atmospheric, solar, and/or geomagnetic effects on the geolocation system. If the offset corresponds to another offset of another road segment (e.g., a “south” offset along one east-west road segment corresponding to a “south” offset along another east-west road segment in the same region as the road segment), then the service provider 104 can determine that the offset is systematic and direction-dependent (e.g., affecting “east-west” road segments). The road segment and the other road segment can be directionally aligned, including parallel, substantially parallel, or within a range of orientations that are primarily parallel (e.g., within 10° of parallel, within 25° of parallel, etc.).

In some embodiments, the corrective action can include adjusting a threshold used for the comparison of the prior probe data collection and the current probe data collection. For example, if the systematic offset is determined to be 2 m and a current offset used to determine a road disturbance is also 2 m, then the service provider 104 can adjust the current offset to be 5 m so that a “lane shift” disturbance may not be indicated unless the difference is greater than 5 m. In some examples, the corrective action can include indicating that the difference does not represent a roadway disruption. For example, the service provider 104 can stop identifying “lane shift” disturbances if a systematic offset is detected, while still identifying “lane closure” disturbances for the same road segment. In some examples, determining the systematic offset can include detecting a geographic region corresponding to the current probe data collection. For example, the current probe data collection can include location information for a road segment in a tropical region (e.g., <22.5° latitude). Based on the determination of the geographic region and/or the determination of the systematic offset, the service provider can take the corrective action.

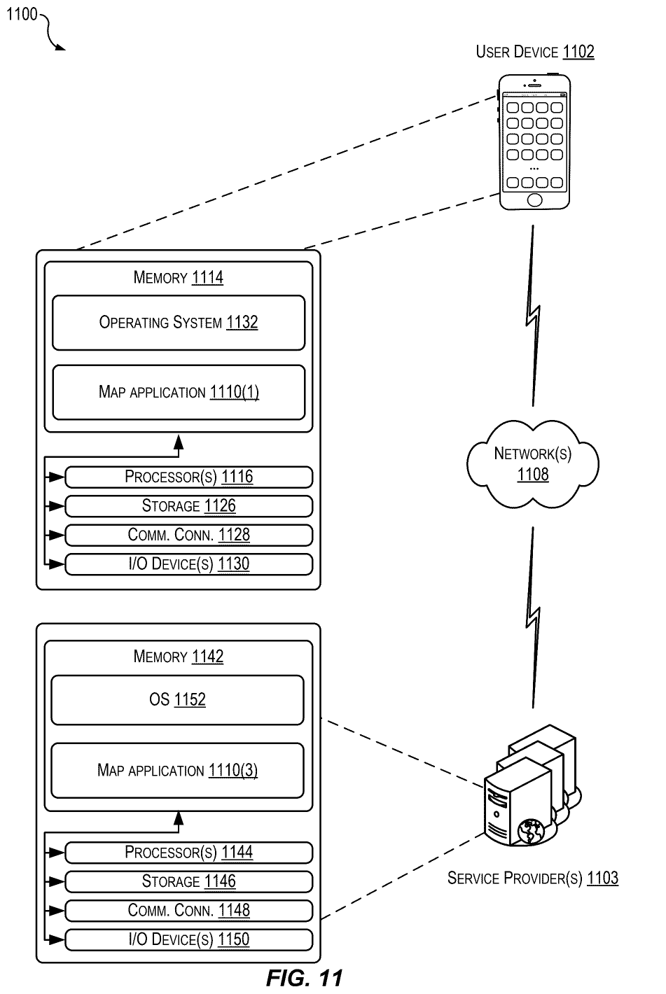

FIG. 11 illustrates an example architecture or environment 1100 configured to implement techniques described herein, according to at least one example. The user device 1102 is an example of the user device 106. The service provider 1103 is an example of the service provider 104. In some examples, the devices may be connected via one or more networks 1108 (e.g., via Bluetooth, WiFi, the Internet, or the like). In some examples, the service provider computers 1103 and the user device 1102 may be configured or otherwise built as a single device. For example, the user device 1102 may be configured to implement the examples described herein as a single computing unit, exercising the examples described above and below without the need for the other devices described.

In some examples, the networks 1108 may include any one or a combination of many different types of networks, such as cable networks, the Internet, wireless networks, cellular networks, satellite networks, other private and/or public networks, or any combination thereof. While the illustrated example represents the user device 1102 accessing the service provider computers 1103 via the networks 1108, the described techniques may equally apply in instances where the user device 1102 interacts with the service provider computers 1103 over a landline phone, via a kiosk, or in any other manner. It is also noted that the described techniques may apply in other client/server arrangements (e.g., set-top boxes, etc.), as well as in non-client/server arrangements (e.g., locally stored applications, peer to peer configurations, etc.).

As noted above, the user device 1102 may be configured to collect and/or manage user activity data, probe data, and the like. In some examples, the user device 1102 may be configured to provide health, fitness, activity, and/or medical data of the user to a third- or first-party application (e.g., the service provider computer 1103). The user device 1102 may be any type of computing device such as, but not limited to, a mobile phone, a smartphone, a personal digital assistant (PDA), a laptop computer, a desktop computer, a thin-client device, a tablet computer, a wearable device, or the like. In some examples, the user device 1102 may be in communication with the service provider computers 1103 via the networks 1108 or via other network connections.

In one illustrative configuration, the user device 1102 may include at least one memory 1114 and one or more processing units (or processor(s)) 1116. The processor(s) may be implemented as appropriate in hardware, computer-executable instructions, firmware, or combinations thereof. Computer-executable instruction or firmware implementations of the processor(s) 1116 may include computer-executable or machine-executable instructions written in any suitable programming language to perform the various functions described. The user device 1102 may also include geo-location devices (e.g., a global navigation satellite system (GNSS) like a global positioning system (GPS) device or the like) for providing and/or recording geographic location information associated with the user device 1102.

The memory 1114 may store program instructions that are loadable and executable on the processor(s) 1116, as well as data generated during the execution of these programs. Depending on the configuration and type of the user device 1102, the memory 1114 may be volatile (such as random access memory (RAM)) and/or non-volatile (such as read-only memory (RGM), flash memory, etc.). The user device 1102 may also include additional removable storage and/or non-removable storage 1126 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 1114 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 1114 and the additional storage 1126, both removable and non-removable, are all examples of non-transitory computer-readable storage media. For example, non-transitory computer readable storage media may include volatile or non-volatile, removable or non-removable media implemented in any method or technology for storage of information such as computer-readable instructions, data structures, program modules, or other data. The memory 1114 and the additional storage 1126 are both examples of non-transitory computer storage media. Additional types of computer storage media that may be present in the user device 1102 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 1102. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 1102 may also contain communications connection(s) that allow the user device 1102 to communicate with a data store, another computing device or server, user terminals, and/or other devices via the network 1108. The user device 1102 may also include I/O device(s) 1130, such as a keyboard, a mouse, a pen, a voice input device, a touch input device, a display, an operating system 1132 and/or one or more application programs or services for implementing the features disclosed herein including a map application 1110(1). In some examples, the map application 1110(1) may be configured to implement the features described herein. For example, the route application may be used to record workouts, change settings relating to location collection mode, compute reconstructed routes, and the like. The user device 1102 may include a memory that includes a similar map application 1110(2), which may be accessible by one or more processors of the user device 1102. The service provider computer may also include a memory 1142 that includes a map application 1110(3). In this manner, the techniques described herein may be implemented by any one, or a combination of more than one, of the computing devices.

The service provider computers 1103 may also be any type of computing device such as, but not limited to, a mobile phone, a smartphone, a PDA, a laptop computer, a desktop computer, a thin-client device, a tablet computer, a wearable device, a server computer, a virtual machine instance, etc. In some examples, the service provider computers 1103 may be in communication with the user device 1102 via the network 1108, or via other network connections.

In one illustrative configuration, the service provider computers 1103 may include at least one memory 1142 and one or more processing units (or processor(s)) 1144. The processor(s) 1144 may be implemented as appropriate in hardware, computer-executable instructions, firmware, or combinations thereof. Computer-executable instruction or firmware implementations of the processor(s) 1144 may include computer-executable or machine-executable instructions written in any suitable programming language to perform the various functions described.

The memory 1142 may store program instructions that are loadable and executable on the processor(s) 1144, as well as data generated during the execution of these programs. Depending on the configuration and type of service provider computer 1103, the memory 1142 may be volatile (such as RAM) and/or non-volatile (such as ROM, flash memory, etc.). The service provider computer 1103 may also include additional removable storage and/or non-removable storage 1146 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 1142 may include multiple different types of memory, such as SRAM, DRAM, or ROM. While the volatile memory described herein may be referred to as RAM, any volatile memory that would not maintain data stored therein once unplugged from a host and/or power would be appropriate. The memory 1142 and the additional storage 1146, both removable and non-removable, are both additional examples of non-transitory computer-readable storage media.

The service provider computer 1103 may also contain communications connection(s) 1148 that allow the service provider computer 1103 to communicate with a data store, another computing device or server, user terminals and/or other devices via the network 1108. The service provider computer 1103 may also include I/O device(s) 1150, such as a keyboard, a mouse, a pen, a voice input device, a touch input device, a display, speakers, a printer, etc.

Turning to the contents of the memory 1142 in more detail, the memory may include an operating system 1152 and/or one or more application programs or services for implementing the features disclosed herein including the map application 1110(3).

Additional examples of embodiments of the present disclosure are provided below.

Example 1 is a computer-implemented method including: accessing a first collection of first path offsets along a segment, the first path offsets corresponding to prior user device probe data generated during a prior interval; determining second path offsets along the segment based on current user device probe data generated during a current interval; generating a second collection of the second path offsets along the segment using the second path offsets; comparing the first collection and the second collection in accordance with a change criterion to identify a difference that represents an anomalous condition along the segment; and generating incident information based on the difference.

Example 2 is the computer-implemented method of Example 1, wherein a particular path offset of the second path offsets represents a particular path of a single electronic user device along the segment and includes a plurality of geolocation points.

Example 3 is the computer-implemented method of Example 2, wherein the particular path offset includes, for each geolocation point of the plurality of geolocation points, a signed perpendicular distance from a centerline of the segment.

Example 4 is the computer-implemented method of Example 3, wherein generating the second collection of the second path offsets includes adding a count to the second collection at the signed perpendicular distance value.

Example 5 is the computer-implemented method of any of Examples 1-4, wherein the current interval occurs after the prior interval.

Example 6 is the computer-implemented method of any of Examples 1-5, wherein the prior interval has a first length that is longer than a second length of the current interval.

Example 7 is the computer-implemented method of any of Examples 1-6, wherein the first collection includes a first histogram and the second collection includes a second histogram.

Example 8 is the computer-implemented method of any of Examples 1-7, wherein the second collection represents a current estimated width of the segment and current estimated borders of the segment.

Example 9 is the computer-implemented method of Example 8, wherein the current estimated width of the segment is different than a historical estimated width of the segment represented by the first collection.

Example 10 is the computer-implemented method of any of Examples 1-9, wherein the change criterion includes a collection width criterion, and wherein the difference represents that the second collection is narrower than the first collection.

Example 11 is the computer-implemented method of Example 10, wherein the anomalous condition includes a narrowing of lanes along the segment.

Example 12 is the computer-implemented method of any of Examples 1-11, wherein the change criterion includes a collection center criterion, and wherein the difference represents that a median of the second collection is offset from a median of the first collection.

Example 13 is the computer-implemented method of Example 12, wherein the anomalous condition includes a shifting of lanes along the segment.

Example 14 is the computer-implemented method of any of Examples 1-13, further including receiving an anomalous condition signal, and wherein generating the incident information includes generating the incident information based on the anomalous condition signal.

Example 15 is the computer-implemented method of Example 14, wherein the anomalous condition signal indicates an anomalous condition to the segment, and wherein receiving the anomalous condition signal includes receiving the anomalous condition signal from a transportation authority.

Example 16 is the computer-implemented method of any of Examples 1-15, further including sending the incident information to an electronic user device that is adjacent to or approaching the segment.

Example 17 is the computer-implemented method of Example 16, wherein the incident information causes the electronic user device to present information about the anomalous condition.

Example 18 is the computer-implemented method of any of Examples 1-17, wherein the second collection includes a rolling window that is updated at a regular interval.

Example 19 is the computer-implemented method of any of Examples 1-18, wherein the prior user device probe data includes geolocation points obtained from geolocation devices of electronic user devices moving along the segment during the prior interval.

Example 20 is the computer-implemented method of any of Examples 1-19, wherein the prior interval includes a summation of a plurality of sub-intervals.

Example 21 is a system including a memory configured to store computer-executable instructions; and a processor configured to access the memory and execute the computer-executable instructions to perform the method of any of Examples 1-20.

Example 22 is one or more non-transitory computer-readable media including computer-executable instructions that, when executed by one or more processors of a computer system, cause the computer system to perform the method of any of Examples 1-20.

Example 23 is a computer-implemented method including accessing a prior probe data collection; determining a current probe data collection; comparing the prior probe data collection and the current probe data collection to identify a difference that represents an anomalous condition along a segment; and generating incident information based on the difference.

Example 24 is the computer-implemented method of Example 23, further including determining, based on the difference, a systematic offset and performing a corrective action based on the systematic offset.

Example 25 is the computer-implemented method of Example 24, wherein the systematic offset includes an offset of a median of the current probe data collection from a median of the prior user device probe data collection, the offset corresponding to another offset of another segment.

Example 26 is the computer-implemented method of Example 25, wherein the systematic offset is direction dependent.

Example 27 is the computer-implemented method of Example 25, wherein the segment and the another segment are directionally aligned.

Example 28 is the computer-implemented method of any of Examples 24-27, wherein the corrective action includes adjusting a threshold used for the comparison of the prior user device probe data collection and the current probe data collection.

Example 29 is the computer-implemented method of any of Examples 24-28, wherein the corrective action includes indicating that the difference does not represent the anomalous condition.

Example 30 is the computer-implemented method of any of Examples 24-29, wherein the anomalous condition is a lane shift.

Example 31 is the computer-implemented method of any of Examples 24-30, wherein determining the systematic offset includes detecting a geographic region corresponding to the current probe data collection.

Example 32 is a system including a memory configured to store computer-executable instructions and a processor configured to access the memory and execute the computer-executable instructions to perform the method of any of Examples 23-31.

Example 33 is one or more non-transitory computer-readable media including computer-executable instructions that, when executed by one or more processors of a computer system, cause the computer system to perform the method of any of Examples 23-31.

Illustrative methods and systems for detection of anomalous conditions using collections of device trajectories are described above. Some or all of these systems and methods may, but need not, be implemented at least partially by architectures such as those shown at least in FIGS. 1-11. While many of the examples are described above with reference to personal, activity, including location-related information, it should be understood that any type of user information or non-user information (e.g., data of any type) may be managed using these techniques. Further, in the foregoing description, various non-limiting examples were described. For purposes of explanation, specific configurations and details are set forth in order to provide a thorough understanding of the examples. However, it should also be apparent to one skilled in the art that the examples may be practiced without the specific details. Furthermore, well-known features were sometimes omitted or simplified in order not to obscure the example being described.

The various examples further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as TC P/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C® or C++, or any scripting language, such as Perl, Python or TC L, as well as combinations thereof. The server(s) may also include database servers, including without limitation those commercially available from Oracle®, Microsoft®, SAP®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SA N) familiar to those skilled in the art. Similarly, any necessary files for performing the functions attributed to the computers, servers or other network devices may be stored locally and/or remotely, as appropriate. W here a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents cited herein are hereby incorporated by reference to the same extent as if each reference were individually and specifically indicated to be incorporated by reference and were set forth in its entirety herein.

As described above, one aspect of the present technology is sharing geolcation information from electronic user devices to a server device, which may include storing some aspect of the data on a server. The present disclosure contemplates that in some instances, this gathered data may include personally identifiable information (PII) data that uniquely identifies or can be used to contact or locate a specific person. Such personal information data can include demographic data, location-based data, telephone numbers, email addresses, Twitter IDs, home addresses, data or records relating to a user's health or level of fitness (e.g., vital sign measurements, medication information, exercise information), date of birth, health record data, or any other identifying or personal or health information.

The present disclosure recognizes that the use of such personal information data, in the present technology, can be used to the benefit of users. For example, the personal information data can be used to provide a family member or friend a view of health data updates. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the U.S., collection of or access to certain health data may be governed by federal and/or state laws, such as the Health Insurance Portability and Accountability Act (HIPAA); whereas health data in other countries may be subject to other regulations and policies and should be handled accordingly. Hence, different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services or other services relating to health record management, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A computer-implemented method, comprising:
accessing a first collection of first path offsets along a segment, the first path offsets corresponding to prior user device probe data generated during a prior interval;
determining second path offsets along the segment based on current user device probe data generated during a current interval;
generating a second collection of the second path offsets along the segment using the second path offsets;
comparing the first collection and the second collection in accordance with a change criterion to identify a difference that represents an anomalous condition along the segment; and
generating incident information based on the difference.

2. The computer-implemented method of claim 1, wherein a particular path offset of the second path offsets represents a particular path of a single electronic user device along the segment and includes a plurality of geolocation points.

3. The computer-implemented method of claim 2, wherein the particular path offset comprises, for each geolocation point of the plurality of geolocation points, a signed perpendicular distance from a centerline of the segment.

4. The computer-implemented method of claim 3, wherein generating the second collection of the second path offsets comprises adding a count to the second collection at the signed perpendicular distance value.

5. The computer-implemented method of claim 1, wherein the current interval occurs after the prior interval.

6. The computer-implemented method of claim 1, wherein the prior interval has a first length that is longer than a second length of the current interval.

7. The computer-implemented method of claim 1, wherein the first collection comprises a first histogram and the second collection comprises a second histogram.

8. The computer-implemented method of claim 1, wherein the second collection represents a current estimated width of the segment and current estimated borders of the segment.

9. The computer-implemented method of claim 8, wherein the current estimated width of the segment is different than a historical estimated width of the segment represented by the first collection.

10. The computer-implemented method of claim 1, wherein the change criterion comprises a collection width criterion, and wherein the difference represents that the second collection is narrower than the first collection.

11. The computer-implemented method of claim 10, wherein the anomalous condition comprises a narrowing of lanes along the segment.

12. The computer-implemented method of claim 1, wherein the change criterion comprises a collection center criterion, and wherein the difference represents that a median of the second collection is offset from a median of the first collection.

13. The computer-implemented method of claim 12, wherein the anomalous condition comprises a shifting of lanes along the segment.

14. The computer-implemented method of claim 1, further comprising receiving a anomalous condition signal, and wherein generating the incident information comprises generating the incident information based on the anomalous condition signal.

15. The computer-implemented method of claim 14, wherein the anomalous condition signal indicates an anomalous condition to the segment, and wherein receiving the anomalous condition signal comprises receiving the anomalous condition signal from a transportation authority.

16. The computer-implemented method of claim 1, further comprising sending the incident information to an electronic user device that is adjacent to or approaching the segment.

17. The computer-implemented method of claim 16, wherein the incident information causes the electronic user device to present information about the anomalous condition.

18. The computer-implemented method of claim 1, wherein the second collection comprises a rolling window that is updated at a regular interval.

19. A system, comprising:
a memory configured to store computer-executable instructions;
a processor configured to access the memory and execute the computer-executable instructions to at least:
access a first collection of first path offsets along a segment, the first path offsets corresponding to prior user device probe data generated during a prior interval;
determine second path offsets along the segment based on current user device probe data generated during a current interval;
generate a second collection of the second path offsets along the segment using the second path offsets;
compare the first collection and the second collection in accordance with a change criterion to identify a difference that represents an anomalous condition along the segment; and
generate incident information based on the difference.

20. One or more non-transitory computer-readable media comprising computer-executable instructions that, when executed by one or more processors of a computer system, cause the computer system to at least:
access a first collection of first path offsets along a segment, the first path offsets corresponding to prior user device probe data generated during a prior interval;
determine second path offsets along the segment based on current user device probe data generated during a current interval;
generate a second collection of the second path offsets along the segment using the second path offsets;
compare the first collection and the second collection in accordance with a change criterion to identify a difference that represents an anomalous condition along the segment; and
generate incident information based on the difference.
